(19) United States
(12) Patent Application Publication
(10) Pub. No.: US 2014/0335871 A1
(43) Pub. Date: Nov. 13, 2014

(54) METHOD, APPARATUS, AND COMPUTER PROGRAM PRODUCT FOR ENABLING NAV PROTECTION FOR RESTRICTED ACCESS WINDOW

(71) Applicant: Nokia Corporation, Espoo (FI)

(72) Inventors: Klaus DOPPLER, Albany, CA (US); Sayantan Choudhury, Berkeley, CA (US); Esa Tuomaala, Berkeley, CA (US); Chittabrata Ghosh, Freemont, CA (US)

(73) Assignee: Nokia Corporation, Espoo (FI)

(21) Appl. No.: 13/892,412

(22) Filed: May 13, 2013

(51) Int. Cl. H04W 16/02

(52) U.S. Cl. CPC H04W 16/02
USPC 455/448

(57) ABSTRACT

Embodiments of the invention provide signaling mechanisms for wireless networks composed of a large number of stations. An example method embodiment comprises: receiving, by a station in an access network, a frame from another station in the access network or from an overlapped access network, indicating time restrictions for reserving a wireless medium, the frame including an indication in a first portion of the frame, indicating the presence of the time restrictions for reserving the wireless medium; and decoding, by the station, at least a second portion occurring after the first portion of the received frame, to determine the time restrictions for reserving the wireless medium, in response to the indication.

### FIELD

The field of technology relates to wireless communication and more particularly to signaling mechanisms for wireless networks composed of a large number of stations.

### BACKGROUND

Modern society has adopted, and is becoming reliant upon, wireless communication devices for various purposes, such as connecting users of the wireless communication devices with other users. Wireless communication devices may vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments are disclosed for overlapping wireless networks including a number of hidden stations.

An example embodiment of the invention includes a method comprising:

receiving, by a station in an access network, a frame from another station in the access network or from an overlapped access network, indicating time restrictions for reserving a wireless medium, the frame including an indication in a first portion of the frame, indicating the presence of the time restrictions for reserving the wireless medium; and

decoding, by the station, a second portion occurring after the first portion of the received frame, to determine the time restrictions for reserving the wireless medium, in response to the indication.

An example embodiment of the invention includes a method comprising:

wherein the station does not need to decode the entire received frame to learn about the time restrictions for reserving the wireless medium, when the time restrictions are for reserving the wireless medium for at least one of the overlapped access network and a third access network.

An example embodiment of the invention includes a method comprising:

wherein the station, sets a NAV to refrain from medium access during the reserved time to reserve the wireless medium for the at least one of the overlapped access network and the third access network.

An example embodiment of the invention includes a method comprising:

wherein the access network and the overlapped access network are both basic service sets and the access node is an access point.

An example embodiment of the invention includes a method comprising:

wherein the access network is a short range network and the overlapped access network is a long range network.

An example embodiment of the invention includes a method comprising:

wherein reserving the wireless medium comprises reserving the wireless medium for one of a restricted access window or a periodic restricted access window.

An example embodiment of the invention includes a method comprising:

wherein the frame is a beacon frame and the indication is a bit located in a frame control field of the frame.

An example embodiment of the invention includes a method comprising:

transmitting, by an access node, a frame indicating time restrictions for reserving a wireless medium for stations in an access network of the of the access node or for overlapped access networks, the frame including an indication in a first portion of the frame, indicating the presence of the time restrictions for reserving the wireless medium; and

exchanging, by the access node, data frames with one or more stations in the access network or the overlapped access networks during a reserved time interval indicated by the time restrictions for reserving the wireless medium.

An example embodiment of the invention includes a method comprising:

wherein the access network and the overlapped access networks are basic service sets and the access node is an access point.

An example embodiment of the invention includes a method comprising:

wherein the access network is a long range network and the overlapped access networks are short range networks.

An example embodiment of the invention includes a method comprising:

wherein the frame further indicates time restrictions for reserving the wireless medium for the access network.

An example embodiment of the invention includes a method comprising:

wherein reserving the wireless medium comprises reserving the wireless medium for a restricted access window for a subset of sensor networks.

An example embodiment of the invention includes a method comprising:

wherein the transmitted frame is a beacon frame and the indication is a bit located in a frame control field of the frame.

An example embodiment of the invention includes a method comprising:

wherein reserving the wireless medium comprises reserving the wireless medium for one of a restricted access window or a periodic restricted access window.

An example embodiment of the invention includes an apparatus comprising:

at least one processor;

at least one memory including computer program code;

the at least one memory and the computer program code configured to, with the at least one processor, cause the apparatus at least to:

receive a frame from a station in an access network of the apparatus or from an overlapped access network, indicating time restrictions for reserving a wireless medium, the frame including an indication in a first portion of the frame, indicating the presence of the time restrictions for reserving the wireless medium; and

decode at least a second portion occurring after the first portion of the received frame, to determine the time restrictions for reserving the wireless medium, in response to the indication.

An example embodiment of the invention includes an apparatus comprising:

wherein the access network and the overlapped access network are both basic service sets and the access node is an access point.

An example embodiment of the invention includes an apparatus comprising:

wherein the access network is a short range network and the overlapped access network is a long range network.

An example embodiment of the invention includes an apparatus comprising:

at least one processor;

at least one memory including computer program code;

the at least one memory and the computer program code configured to, with the at least one processor, cause the apparatus at least to:

transmit a frame indicating time restrictions for reserving a wireless medium for stations in an access network of the apparatus or for overlapped access networks, the frame including an indication in a first portion of the frame, indicating the presence of the time restrictions for reserving the wireless medium; and

exchange data frames with one or more stations in the access network or the overlapped access networks during an a reserved time interval indicated by the time restrictions for reserving the wireless medium.

An example embodiment of the invention includes a computer program product comprising computer executable program code recorded on a computer readable, non-transitory storage medium, the computer executable program code comprising:

code for receiving, by a station in an access network, a frame from another station in the access network or from an overlapped access network, indicating time restrictions for reserving a wireless medium, the frame including an indication in a first portion of the frame, indicating the presence of the time restrictions for reserving the wireless medium; and

code for decoding, by the station, at least a second portion occurring after the first portion of the received frame, to determine the time restrictions for reserving the wireless medium, in response to the indication.

An example embodiment of the invention includes a computer program product comprising computer executable program code recorded on a computer readable, non-transitory storage medium, the computer executable program code comprising:

code for transmitting, by an access node, a frame indicating time restrictions for reserving a wireless medium for stations in an access network of the of the access node or for overlapped access networks, the frame including an indication in a first portion of the frame, indicating the presence of the time restrictions for reserving the wireless medium; and

code for exchanging, by the access node, data frames with one or more stations in the access network or the overlapped access networks during a reserved time interval indicated by the time restrictions for reserving the wireless medium.

The resulting example embodiments provide signaling mechanisms for overlapping wireless networks including a number of hidden stations.

### DESCRIPTION OF THE FIGURES

FIG. 1 is an example network diagram of a long-range IEEE 802.11ah network and two short-range IEEE 802.11ah networks that overlap the long-range network. The figure shows the long-range access point transmitting the beacon frame indicating time restrictions for reserving a wireless medium for overlapped access networks, the frame including an Restricted Access Window Parameter Set (RPS) indication in a first portion of the frame, indicating the presence of the time restrictions for reserving the wireless medium, according to an example embodiment of the invention. The figure shows the long-range access point transmitting a beacon indicating the beginning instant T1 and the ending instant T2 of a first restricted access time interval.

FIG. 2A is an example format diagram of a beacon frame that contains a CRC information element that allows a station to decode the beacon content before the CRC information element, without decoding the whole beacon. Based on this information being positioned before the CRC information element, a station may, for example, decide not to decode the whole beacon, since the beacon information has not changed from the last successfully received beacon. The Restricted Access Window Parameter Set (RPS) information element is shown located before the first CRC information element. In this way, a station that would not otherwise decode a beacon, would only be required to receive and decode a minimal amount of the information elements included in the beacon. The figure shows the IEEE 802.11ah format of the frame control field of the beacon, which includes the RPS indication as a bit, to indicate the presence of an RPS information element, according to an example embodiment of the invention.

FIG. 2B is an example format diagram of the IEEE 802.11 frame control fields that may alternately be used in the beacon of FIG. 2A, according to an example embodiment of the invention.

FIG. 3A is an example format diagram of the Restricted Access Window Parameter Set (RPS) information element that contains the RAW Assignments. If a station is not part of the RAW Group, it will set its NAV according to the information in the RAW assignment. The RAW Start Time measures the beginning of the RAW in TU (ms) from the end of the beacon frame transmission and the RAW duration the duration of the RAW measured in TU from the start time of the RAW. A station will set its NAV from the RAW Start Time until RAW Start Time+RAW Duration.

FIG. 3B is an example format diagram of the Restricted Access Window Parameter Set (RPS) information element that contains the Periodic RAW (PRAW) Assignments.

FIG. 4 is an example flow diagram of operational steps in the wireless station device, according to an example embodiment of the invention.

FIG. 5 is an example flow diagram of operational steps in the wireless long-range access point device, according to an example embodiment of the invention.

FIG. 6 is an example functional block diagram, illustrating an example short-range or long-range station device, according to an example embodiment of the invention.

FIG. 7 is an example functional block diagram, illustrating an example short-range or long-range access point device, according to an example embodiment of the invention.

FIG. 8 illustrates an example embodiment of the invention, wherein examples of removable storage media are shown. The removable storage media are based on magnetic, electronic and/or optical technologies, such as magnetic disks, optical disks, semiconductor memory circuit devices and micro-SD memory cards (SD refers to the Secure Digital standard). The removable storage media are for storing data and/or computer program code as an example computer program product, in accordance with at least one embodiment of the present invention.

### DISCUSSION OF EXAMPLE EMBODIMENTS OF THE INVENTION

This section is organized into the following topics:

A. WLAN Communication Technology

B. Enabling NAV Protection For Restricted Access Window

### A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j, k, n, r, s, u, v, and z protocols, into the base standard IEEE 802.11-2012, Wireless Medium Access Control (MAC) and Physical Layer (PHY) Specifications, February 2012. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11ah WLAN standard is being developed for operation below 1 GHz and will have a greater range and lower obstruction losses due to its longer wavelength.

According to an example embodiment, an IEEE 802.11 WLAN may be organized as an independent basic service set (IBSS) or an infrastructure basic service set (BSS). The access point (AP) in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point (AP) in an Infrastructure BSS may bridge traffic out of the BSS onto a distribution network. STAs that are members of the BSS may exchange packets with the AP.

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request to Send (RTS) and the receiver may respond with a Clear to Send (CTS). The channel may be cleared by these two messages, since all STAs that hear at least one of the CTS and the CTS may suppress their own start of a transmission. The Request to Send (RTS) packet sent by the sender and the Clear to Send (CTS) packet sent in reply by the intended receiver, may alert all other devices within range of the sender or the receiver, to refrain from transmitting for the duration of the main packet.

According to an example embodiment, when data packets are transmitted, each station may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium may be busy. Use of the NAV for carrier sensing is called virtual carrier sensing. STAs receiving a valid frame may update their NAV with the information received in the duration field for all frames where the new duration value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a duration value of zero, to release the channel.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel may be busy. A carrier sensing scheme may be used wherein a node wishing to transmit data has to first listen to the channel for a predetermined amount of time to determine whether or not another node may be transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm may be the truncated binary exponential backoff, wherein after a certain number of increases, the transmission timeout reaches a ceiling and thereafter does not increase any further.

According to an example embodiment, it may also be possible to start data transmission directly without RTS-CTS signaling and in that case, the first packet carries information similar to the RTS to start protection.

According to an example embodiment, an IEEE 802.11 WLAN may also be organized as an independent basic service set (IBSS). Wireless devices in an independent basic service set (IBSS) communicate directly with one another and there is no access point in the IBSS. WLAN ad hoc networks have an independent configuration where the terminal devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format may be identical to that of an IEEE 48-bit address. In an ad hoc network, the BSSID may be a locally administered, individual address that is generated randomly by the device that starts the ad hoc network.

Synchronization is the process of the devices in an ad hoc network getting in step with each other, so that reliable communication may be possible. The MAC may provide the synchronization mechanism to allow support of physical layers that make use of frequency hopping or other time-based mechanisms where the parameters of the physical layer change with time. The process may involve beaconing to announce the presence of an ad hoc network, and inquiring to find an ad hoc network. Once an ad hoc network is found, a device may join the ad hoc network. This process may be entirely distributed in ad hoc networks, and may rely on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

Since there is no AP, the terminal device that starts the ad hoc network may begin by resetting its TSF timer to zero and transmitting a beacon, choosing a beacon period. This establishes the basic beaconing process for this ad hoc network. After the ad hoc network has been established, each device in the ad hoc network will attempt to send a beacon after the target beacon transmission time (TBTT) arrives. To minimize actual collisions of the transmitted beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process may be a purely local process that occurs entirely internal to the terminal device. There may be no indication to the outside world that a device has joined a particular ad hoc network. Joining an ad hoc network may require that all of the terminal device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the terminal device has joined the ad hoc network and may be ready to begin communicating with the devices in the ad hoc network.

A terminal device may associate or register with an access point to gain access to the network managed by the access point. Association allows the access point to record each terminal device in its network so that frames may be properly delivered. After the terminal device authenticates to the access point, it sends an association request to the access point. Association allows the access point to record each terminal device so that frames may be properly delivered. The association request is a management frame that contains information describing the terminal device, such as its capability, listening interval, SSID, supported rates, power capability, QoS capability, and the like. The access point processes the association request and grants association by replying with an association response frame. The association response frame is a management frame that contains information describing the access point, such as its capability and supported rates. The association response frame also includes an association ID (AID) that is assigned by the access point to identify the terminal device for delivery of buffered frames. The AID field is a value assigned by the access point during association, which represents the 16-bit ID of a terminal device. The length of the AID field is two octets, the value assigned as the AID is in the range 1-2007, and it is placed in the 14 lowest significant bits (LSBs) of the AID field, with the two most significant bits (MSBs) of the AID field each set to “1”.

An access point may maintain a polling list for use in selecting terminal devices in its network, which are eligible to receive contention free polls (CF-Polls) during contention free periods. The polling list is used to force the polling of contention free terminal devices capable of being polled, whether or not the access point has pending traffic to transmit to those terminal devices.

Whenever an access point needs to poll a group of terminal devices who already know their respective AIDs within the network that the access point manages, a contention free (CF) group poll message may be sent by the access point.

After receiving contention free (CF) group poll message from the access point, a terminal device in the group that has data to send, transmits a response message or acknowledgement (ACK) to access point, after waiting for a short interframe space (SIFS) interval.

The access point (AP) in an infrastructure BSS assists those mobile wireless devices (STAs) attempting to save power. The legacy IEEE 802.11e Wireless LAN standards provides for support of low power operation in handheld and battery operated STAs, called automatic power save delivery (APSD). A STA capable of APSD and currently in the power saving mode, will wake up at predetermined beacons received from the AP to listen to a Traffic Indication Map (TIM). If existence of buffered traffic waiting to be sent to the STA may be signaled through the TIM, the STA will remain awake until AP sends out all the data. The STA does not need to send a polling signal to the AP to retrieve data, which may be the reason for the term “automatic” in the acronym APSD.

A Traffic Indication Map (TIM) is a field transmitted in beacon frames, used to inform associated wireless terminal devices or STAs that the access point has buffered data waiting to be transmitted to them. Access points buffer frames of data for STAs while they are sleeping in a low-power state. The access point transmits beacons at a regular interval, the target beacon transmission time (TBTT). The Traffic Indication Map (TIM) information element in the periodically transmitted beacon frame, indicates which STAs have buffered data waiting to be accessed in the access point. Each frame of buffered data may be identified by an association identifier (AID) associated with a specific STAs. The AID may be used to logically identify the STAs to which buffered frames of data are to be delivered. The traffic indication map (TIM) contains a bitmap, with each bit relating to a specific association identifier (AID). When data is buffered in the access point for a particular association identifier (AID), the bit is “1”. If no data is buffered, the bit for the association identifier (AID) is “0”. Wireless terminal devices must wake up and listen for the periodic beacon frames to receive the Traffic Indication Map (TIM). By examining the TIM, a STAs may determine if the access point has buffered data waiting for it. To retrieve the buffered data, the STAs may use a power-save poll (PS-Poll) frame. After transmitting the PS-Poll frame, the client mobile station may stay awake until it receives the buffered data or until the bit for its association identifier (AID) in the Traffic Indication Map (TIM) is no longer set to “1”, indicating that the access point has discarded the buffered data.

Two variations of the APSD feature are unscheduled automatic power save delivery (U-APSD) and scheduled automatic power save delivery (S-APSD). In U-APSD, the access point (AP) may be always awake and hence a mobile wireless device (STA) in the power save mode may send a trigger frame to the AP when the STA wakes up, to retrieve any queued data at the AP. In S-APSD, the AP assigns a schedule to a STA and the STA wakes up, sends a power save poll packet to the AP in order to retrieve from the AP any data queued. An AP may maintain multiple schedules either with the same STA or with different STAs in the infrastructure BSS network. Since the AP may be never in sleep mode, an AP will maintain different scheduled periods of transmission with different STAs in the infrastructure BSS network to ensure that the STAs get the maximum power savings.

The IEEE 802.11ah WLAN standard operating below 1 GHz, has a greater range and lower obstruction losses due to its longer wavelength. IEEE 802.11ah provides wireless LAN operation in the sub-1 GHz range considered appropriate for sensor networks, machine-to-machine, cellular offload, and smart grid applications. IEEE 802.11ah defines three use case categories:

Use Case 1: Sensors and meters;

Use Case 2: Backhaul sensor and meter data; and

Use Case 3: Extended range Wi-Fi

A principal application of IEEE 802.11ah may be sensor networks, for example in smart metering, where the measurement information at each sensor node may be transmitted to an access point. In example sensor applications, the data packet size may be a few hundred bytes, the sensors may have a low duty-cycle, transmitting data every few minutes, and the number of sensor devices may be as large as 6000 devices communicating with an access point.

The IEEE 802.11ah WLAN standard organizes the STAs associated to a network, into groups. The association response frame transmitted by the access point device, may indicate the group ID, along with the conventional association ID (AID) field that associates the STA to the access point. The group IDs may be numbered in descending order of group priority for quality of service (QoS) STAs. The access point may base its group ID number for the case of non-QoS STAs on their respective association times. In this manner, the access point may determine which STAs are members of which group. Based on the association request frame from a new requesting STA, the access point either uses QoS parameters or non-QoS parameters, such as proximity, to decide to which group the new STA is a member. The corresponding group ID of the group to which the new STA is assigned may be then sent by the access point to the STA in response to the association request message. The association response frame indicates the group ID, along with the conventional AID field that associates the STA to the access point.

The IEEE 802.11ah WLAN standard includes Synchronized Distributed Coordination Function (DCF) uplink channel access by STAs. The beacon frame transmitted by the access point, may define a restricted access period, referred to as a restricted access window (RAW). Each Restricted Access Window restricts the access to the wireless medium to the group of STA. Each restricted access window may comprise multiple time slots and each time slot may be allocated to STAs paged in the traffic indication map (TIM). Uplink data transmissions, such as PS-polling operations, may be facilitated by transmitting the packet in a time slot in an uplink restricted access window. Downlink data transmission may be facilitated by the transmission of data packets in a downlink restricted access window. An example procedure for uplink channel access may include:
An awakened STA that decodes the beacon, sends a PS-Poll packet or an uplink data indication packet when its traffic indication map (TIM) bit may be set to one;
The STA may determine its channel time slot in an uplink restricted access window based on its AID bit position in the traffic indication map (TIM);
The STA may contend for access to the time slot with other STAs in the same group;
After resolving PS-Polls from STAs, the access point may broadcast a downlink allocation packet that may be positioned after the uplink restricted access window and before the downlink restricted access window, which may include a Block ACK, the duration of downlink restricted access window, and/or allocated downlink time slot for the STAs.

The access point includes in its transmitted beacon frame, a Restricted Access Window Parameter Set (RPS) information element (IE) to inform the STAs within a group which may be defined by a range of AIDs of [1] the start time of the restricted access window assigned to them and [2] the medium access duration assigned to them. The Restricted Access Window Parameter Set element may include: [1] the range of AID in the group; [2] a prohibition interval [3] restricted access windows assigned to other groups of STAs; [4] periodic restricted access windows, and [5] RAW Group (Page ID, RAW Start AID, RAW End AID), RAW Start Time, RAW Duration, Options Fields (a. Access restricted to paged STA only, and b. Group/Resource allocation frame indication), Slot definition. The restricted access window duration, as the name implies, specifies the duration following the start of the restricted access window, after which the restricted access window terminates, which applies to all STAs. Prohibition interval is an interval where no station in the BSS is allowed to access the wireless medium. It may also be signaled in a separate Information element. In an example embodiment of the invention, the early indication may indicate either the presence of a prohibition interval or the restricted access window. The flexible assignment of the Restricted Access Window group element in the beacon frame enables the access point to place a given STA in one group in one beacon frame and move that STA to another group in the next consecutive beacon frame.

### B. Enabling NAV Protection for Restricted Access Window

In sensor networks and smart grid applications, large numbers of wireless terminals or STAs, both fixed and mobile, arrayed over kilometer-sized areas, will need to communicate with a long-range access point device. In the case of IEEE 802.11 ah networks, it may be envisioned to have a Wi-Fi network of 6000 wireless terminal devices or STAs being served by a long-range access point. The STAs may operate on battery power and must conserve their power during long periods of inactivity punctuated by short durations of communication sessions.

In accordance with an example embodiment of the invention, an efficient way is provided for signaling to a wireless station that a restricted access window is scheduled by a beacon frame and rules are provided for how a station may set the Network Allocation Vector (NAV). In this manner, stations in other BSS networks and stations in the same BSS network, for example non-TIM stations, that would not have otherwise decoded the beacon frame, are prevented from accessing the channel. Non-TIM stations are stations that do not have TIM bits assigned. These stations send PS-Polls to see if there is downlink data buffered. They don't decode the beacon. Protection is provided to prevent hidden stations from transmitting interfering packets causing collisions.

In accordance with an example embodiment of the invention, an early indication is provided e.g. in the Frame Control Field of a beacon frame, indicating that the beacon frame contains a Restricted Access Window Parameter Set (RPS) information element (IE) to schedule a restricted access window (RAW). If a station (STA) receives this early indication, it shall decode at least further part of the beacon and if the station is not part of the group of stations allowed to access the RAW, it shall set its NAV for the duration of the RAW.

In accordance with an example embodiment of the invention, the RPS IE may be positioned in the first segment of the beacon, before the mid Cyclic Redundancy Check (CRC) IE. In this manner, a station that is not interested in the full beacon content, does not have to decode the full beacon.

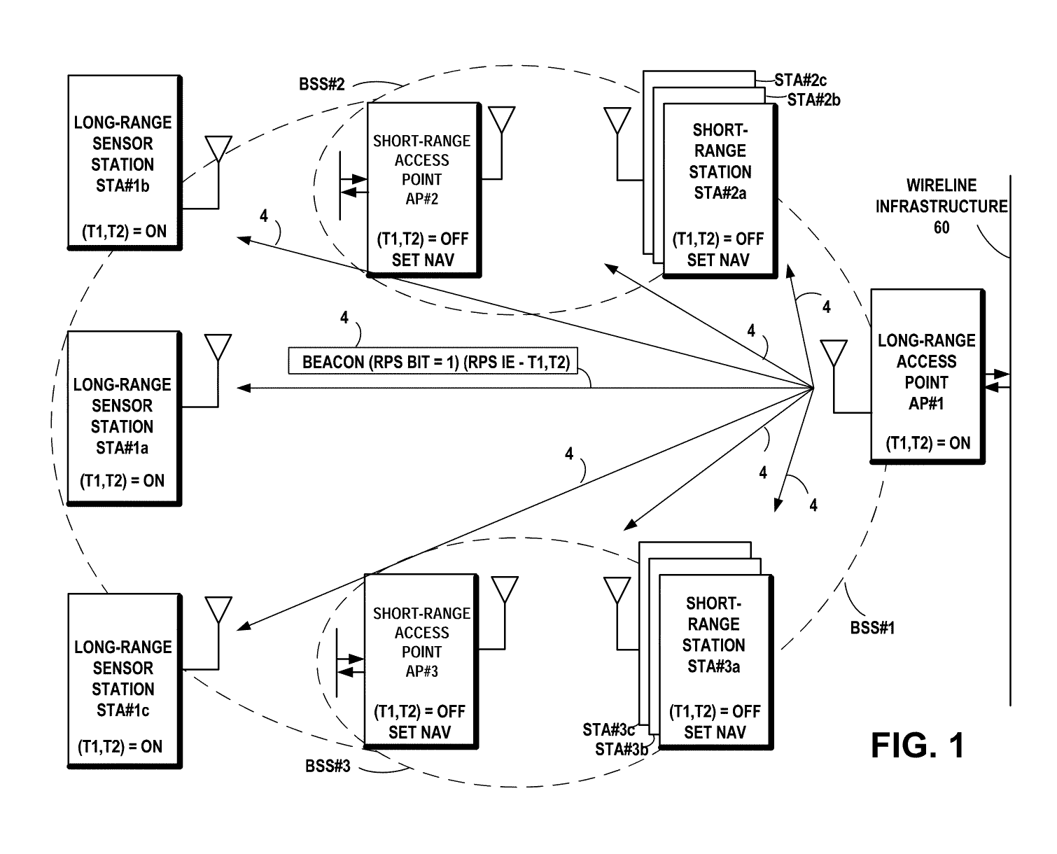

FIG. 1 is an example network diagram of a long-range IEEE 802.11ah network BSS#1 and two short-range IEEE 802.11ah networks BSS#2 and BSS#3 that overlap the long-range network. The figure shows the long-range access point AP#1 transmitting the beacon frame 4 indicating time restrictions T1, T2 for reserving a wireless medium for overlapped access networks. The frame 4 includes a Restricted Access Window Parameter Set (RPS) indication in a beginning or first portion of the frame 4, indicating the presence of the Restricted Access Window Parameter Set (RPS) information element (IE) in a later occurring second portion of the frame. The RPS IE informs the STAs within a group of [1] the interval they may sleep before they may contend for the medium and [2] their medium access duration. The RPS IE includes the time restrictions T1, T2 for reserving the wireless medium, according to an example embodiment of the invention. The figure shows the long-range access point AP#1 transmitting the beacon 4 indicating the beginning instant T1 and the ending instant T2 of a restricted access time interval.

The figure shows the respective short-range access points AP#2 and AP#3. The AP#1 may schedule protected frame transmissions from the long-range sensor stations STA#1a, STA#1b, and STA#1c, associated with the long-range access point AP#1, between an instant T1 and an instant T2, according to an example embodiment of the invention.

The figure shows the long-range access point AP#1 transmitting a beacon 4 indicating the beginning instant T1 and the ending instant T2 of a restricted access time interval (T1,T2). The restricted access time interval may be for the short-range stations STA#2a, STA#2b, and STA#2c, associated with the short-range access point AP#2. The restricted access time interval may be for STA#3a, STA#3b, and STA#3c associated with the short-range access point AP#3. These stations are in the two overlapping short-range networks BSS#2 and BSS#3. The long-range beacon 4 may be received by the long-range sensor stations STA#1a, STA#1b, and STA#1c, associated with the long-range access point AP#1. The long-range beacon 4 may indicate to the long-range sensor stations that they may access the medium between the instant T1 and the instant T2. The figure shows each of the long-range sensor stations STA#1a, STA#1b, and STA#1c recognizing that it may contend for the medium during the interval (T1,T2), according to an example embodiment of the invention.

In accordance with an example embodiment of the invention, the beacon 4 may be also received by the short-range access point AP#2, the short-range stations STA#2a, STA#2b, and STA#2c, the short-range access point AP#3, and short-range stations STA#3a, STA#3b, and STA#3c. The beacon 4 may indicate to them the restricted access time interval (T1,T2) for the short-range stations STA#2a, STA#2b, and STA#2c, associated with the short-range access point AP#2 and STA#3a, STA#3b, and STA#3c, associated with the short-range access point AP#3 in the two overlapping short-range networks BSS#2 and BSS#3. The figure shows each of the short-range stations STA#2a, STA#2b, and STA#2c, associated with the short-range access point AP#2 recognizing that the short-range stations in the respective BSS#2 and BSS#3 must remain quiet during the interval (T1,T2), according to an example embodiment of the invention. The figure shows each of the short-range stations STA#3a, STA#3b, and STA#3c recognizing that the short-range stations in the respective BSS#2 and BSS#3 must remain quiet during the interval (T1,T2), according to an example embodiment of the invention.

The Restricted Access Window Parameter Set (RPS) information element in the beacon 4, contains the RAW Assignments. If a short-range station STA#2a, STA#2b, and STA#2c is not part of the RAW Group, it will set its NAV according to the information in the RAW assignment. The RAW Start Time T1 measures the beginning of the RAW in TU (ms) from the end of the beacon frame transmission and the RAW duration the duration of the RAW measured in TU from the start time of the RAW. A station will set its NAV from the RAW Start Time until RAW Start Time+RAW Duration.

After the long-range access point AP#1 has transmitted the beacon 4, it may exchange data frames with one or more stations in the overlapped access networks during a reserved time interval indicated by the time restrictions for reserving the wireless medium, in the Restricted Access Window Parameter Set (RPS) information element.

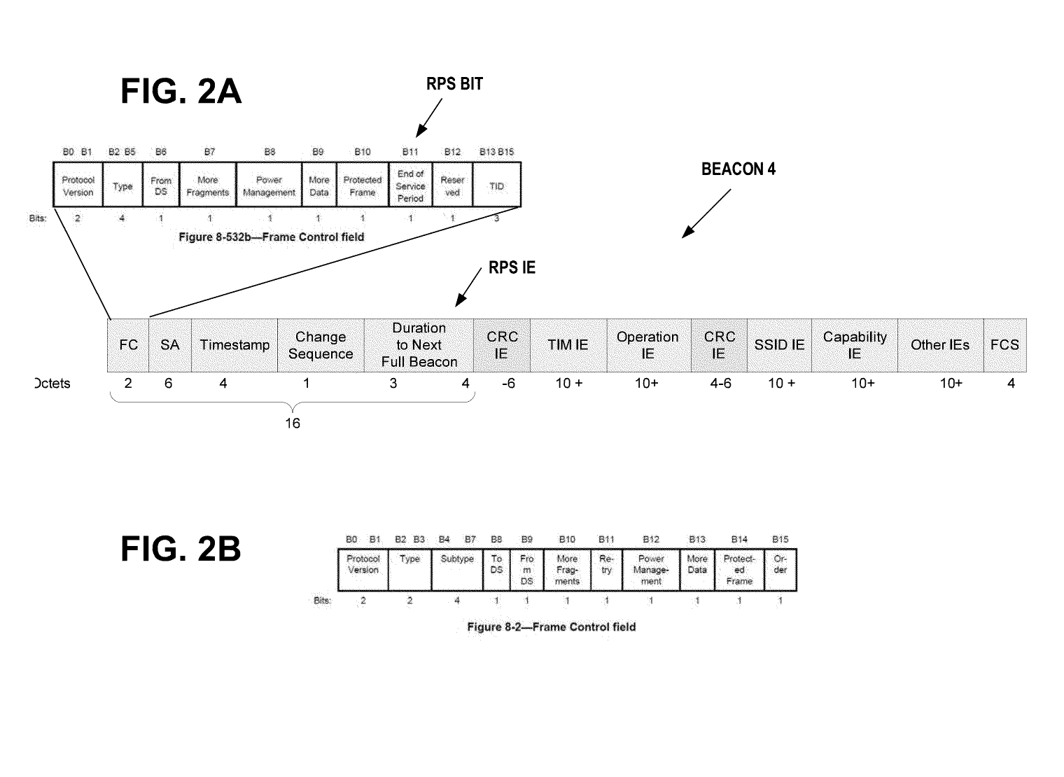

FIG. 2A is an example format diagram of a beacon frame 4. The frame control field in the beginning or first portion of the beacon 4, includes the RPS bit indicating the presence of the Restricted Access Window Parameter Set (RPS) information element (IE) in a later occurring second portion of the frame, which specifies time restrictions for reserving the wireless medium. A station STA#2a, STA#2b, and STA#2c receiving the beacon 4 will decode at least the second portion occurring after the first portion of the received beacon 4, to determine the time restrictions for reserving the wireless medium, in response to the RPS bit indication. The frame may or may not comprise time restrictions for reserving the wireless medium. If the indication (in the beginning or first portion of the frame) indicates absence of time restrictions for reserving the wireless medium, the station does not decode the frame further.

The beacon 4 includes the Restricted Access Window Parameter Set (RPS) information element (IE) positioned at a location in the beacon before the location of the CRC IE. In this manner, a station STA#2a, STA#2b, and STA#2c is able to decode the beacon content at an early point before the occurrence of the CRC information element, without decoding the whole beacon. Based on the RPS IE being positioned before the CRC information element, a station STA#2a, STA#2b, and STA#2c may, for example, decide not to decode the whole beacon, since the beacon information has not changed from the last successfully received beacon.

The Restricted Access Window Parameter Set (RPS) information element is shown located before the first CRC information element in the beacon 4. In this manner, a station STA#2a, STA#2b, and STA#2c that would not otherwise decode a beacon, would only be required to receive and decode a minimal amount of the information elements included in the beacon. The figure shows the IEEE 802.11ah format of the frame control field of the beacon 4, which includes the RPS indication as a bit, to indicate the presence of an RPS information element, according to an example embodiment of the invention.

FIG. 2B is an example format diagram of the IEEE 802.11 frame control fields that may alternately be used in the beacon 4 of FIG. 2A, according to an example embodiment of the invention.

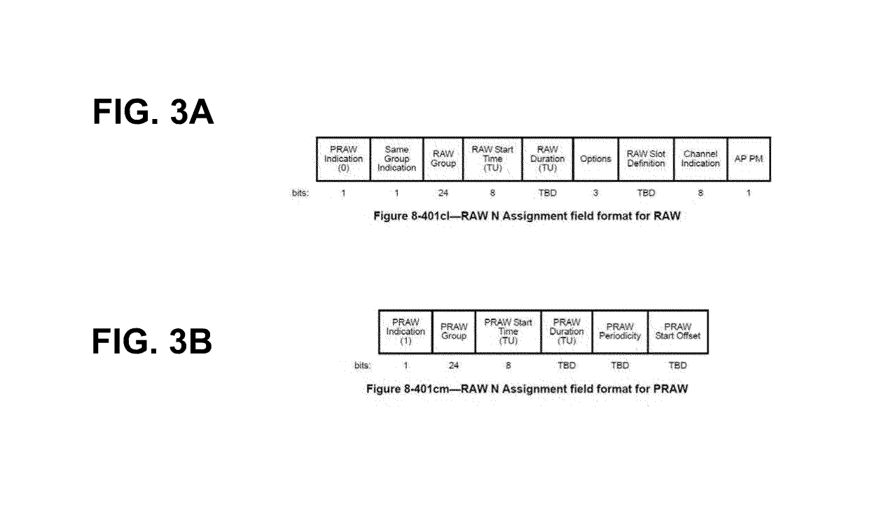

FIG. 3A is an example format diagram of the Restricted Access Window Parameter Set (RPS) information element in the beacon 4, which contains the RAW Assignments. If a station STA#2a, STA#2b, and STA#2c is not part of the RAW Group, it will set its NAV according to the information in the RAW assignment. The RAW Start Time measures the beginning of the RAW in TU (ms) from the end of the beacon frame transmission and the RAW duration the duration of the RAW measured in TU from the start time of the RAW. A station STA#2a, STA#2b, and STA#2c will set its NAV from the RAW Start Time until RAW Start Time+RAW Duration.

FIG. 3B is an example format diagram of the Restricted Access Window Parameter Set (RPS) information element in beacon 4, which contains the Periodic RAW (PRAW) Assignments.

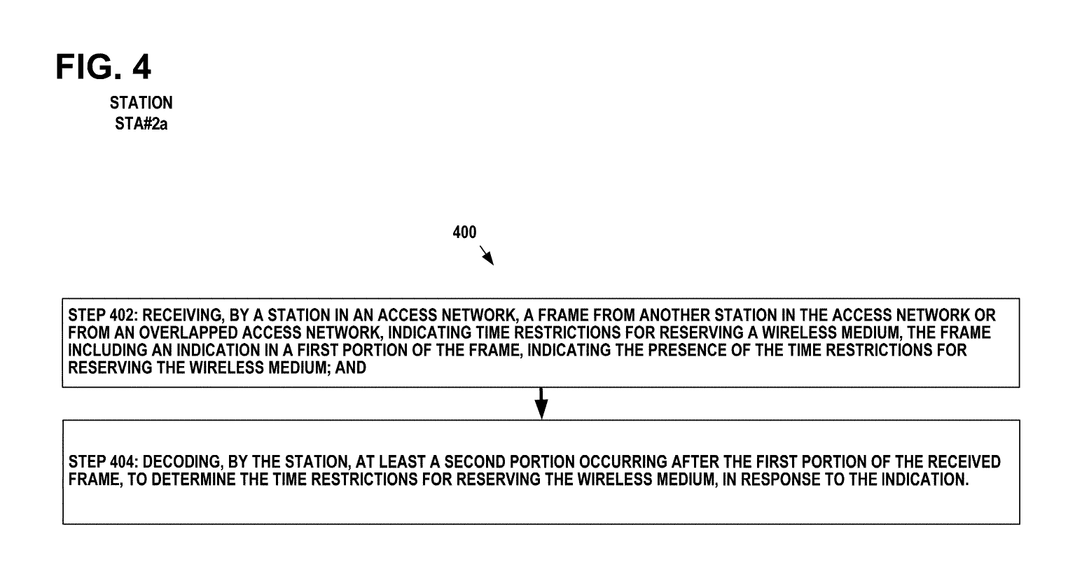

FIG. 4 is an example flow diagram 400 of operational steps in the wireless station device STA#2a, STA#2b, and STA#2c, according to an example embodiment of the invention. The wireless station device may be associated to a short range network or to a long range network, as an examples. The steps of the flow diagram represent computer code instructions stored in the RAM and/or ROM memory of the wireless device A, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 402: receiving, by a station in an access network, a frame from another station in the access network or from an overlapped access network, indicating time restrictions for reserving a wireless medium, the frame including an indication in a first portion of the frame, indicating the presence of the time restrictions for reserving the wireless medium; and

Step 404: decoding, by the station, at least a second portion occurring after the first portion of the received frame, to determine the time restrictions for reserving the wireless medium, in response to the indication.

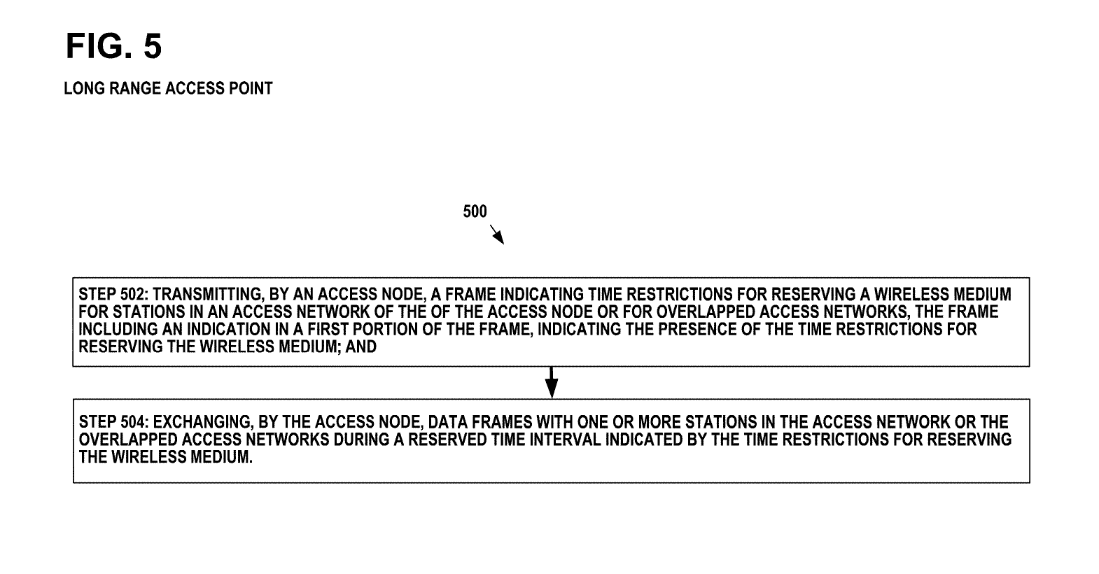

FIG. 5 is an example flow diagram 500 of operational steps in the wireless long-range access point device AP#1, according to an example embodiment of the invention. The steps of the flow diagram represent computer code instructions stored in the RAM and/or ROM memory of the wireless device A, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 502: transmitting, by an access node, a frame indicating time restrictions for reserving a wireless medium for stations in an access network of the of the access node or for overlapped access networks, the frame including an indication in a first portion of the frame, indicating the presence of the time restrictions for reserving the wireless medium; and

Step 504: exchanging, by the access node, data frames with one or more stations in the access network or the overlapped access networks during a reserved time interval indicated by the time restrictions for reserving the wireless medium.

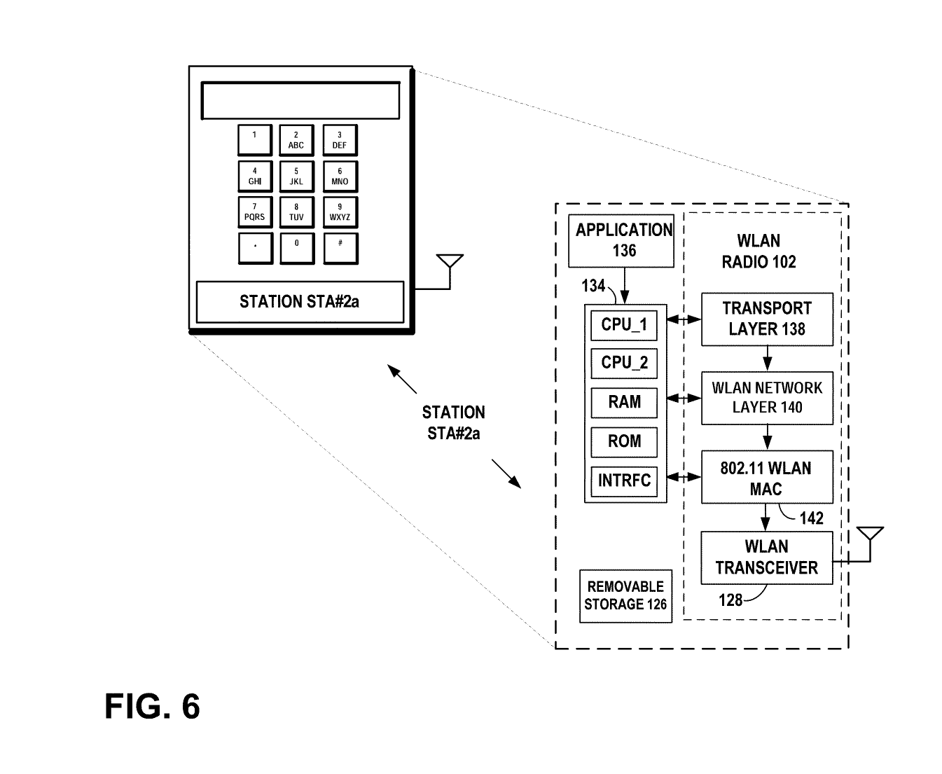

FIG. 6 is an example functional block diagram, illustrating an example short-range or long-range station, according to an example embodiment of the invention. The long-rang stations STA#1a, STA#1b, and STA#1c and the short-range stations STA#2a, STA#2b, and STA#2c, and STA#3a, STA#3b, and STA#3c, may have similar components, except for their particular applications. The short-range stations STA#2a, STA#2b, and STA#2c and STA#3a, STA#3b, and STA#3c may include an application to offload cellular telephone network traffic exchanged with respective short-range access points AP#2 and AP#3, for carrying by local WiFi networks. The long-rang stations STA#1a, STA#1b, and STA#1c may include sensors for smart metering, where the measurement information at each sensor node may be transmitted to a long-range access point AP#1.

The example STA#1a may include a processor 134 that may include a dual or multi-core central processing unit CPU_1 and CPU_2, a RAM memory, a ROM memory, and an interface for a keypad, display, and other input/output devices. The example STA#1a may include a protocol stack, including the transceiver 128 and IEEE 802.11 MAC 142, which may be based, for example, on the IEEE 802.11ah WLAN standard. The protocol stack may also include a network layer 140, a transport layer 138, and an application program 136.

In an example embodiment, the interface circuits in FIG. 6 may interface with one or more radio transceivers, battery and other power sources, key pad, touch screen, display, microphone, speakers, ear pieces, camera or other imaging devices, etc. The RAM and ROM may be removable memory devices 126 such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 9, may be based on magnetic, electronic and/or optical technologies. Examples of removable storage media 126 include magnetic disks, optical disks, semiconductor memory circuit devices and micro-SD memory cards (SD refers to the Secure Digital standard). The removable storage media 126 may store data and/or computer program code as an example computer program product, in accordance with at least one embodiment of the present invention.

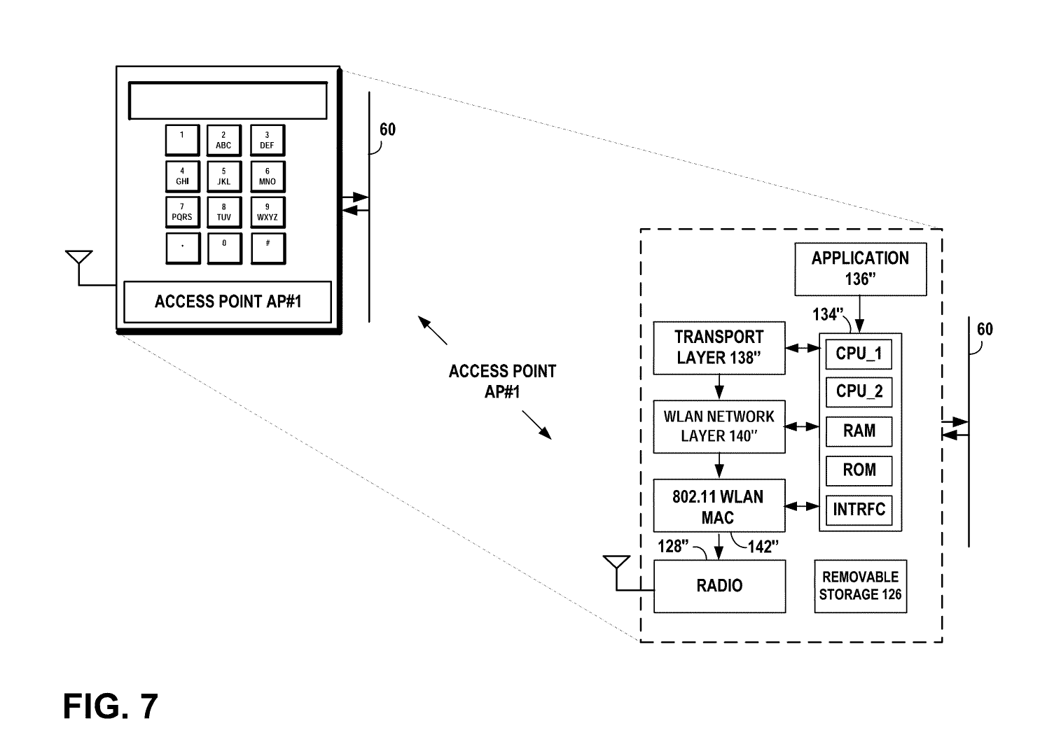

FIG. 7 is an example functional block diagram, illustrating an example long-range access point AP#1, according to an example embodiment of the invention. The long-rang access point AP#1 and the short-range access point AP#2 and AP#3 may have similar components, except for their particular applications. The short-range access points AP#2 and AP#3 may include an interface to a cellular telephone network to offload cellular telephone network traffic, for transfer to their respective, associated short-range stations STA#2a, STA#2b, and STA#2c and STA#3a, STA#3b, and STA#3c for carrying by local WiFi networks. The long-rang access point AP#1 may include an application for forwarding sensor data, where the measurement information received from long-rang sensor stations STA#1a, STA#1b, and STA#1c, may be forwarded for further processing of the sensor data.

The example access point AP#1 may include a processor 134″ that may include a dual or multi-core central processing unit CPU_1 and CPU_2, a RAM memory, a ROM memory, and an interface for a keypad, display, and other input/output devices. The example access point AP#1 may include a protocol stack, including the transceiver 128″ and IEEE 802.11 ah MAC 142″, which may be based, for example, on the IEEE 802.11ah WLAN standard. The protocol stack may also include a network layer 140″, a transport layer 138″, and an application program 136″.

In an example embodiment, the interface circuits in FIG. 7 may interface with one or more radio transceivers, battery and other power sources, key pad, touch screen, display, microphone, speakers, ear pieces, camera or other imaging devices, etc. The RAM and ROM may be removable memory devices 126″ such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 9, may be based on magnetic, electronic and/or optical technologies. Examples of removable storage media 126 may include magnetic disks, optical disks, semiconductor memory circuit devices and micro-SD memory cards (SD refers to the Secure Digital standard). The removable storage media 126 may store data and/or computer program code as an example computer program product, in accordance with at least one embodiment of the present invention.

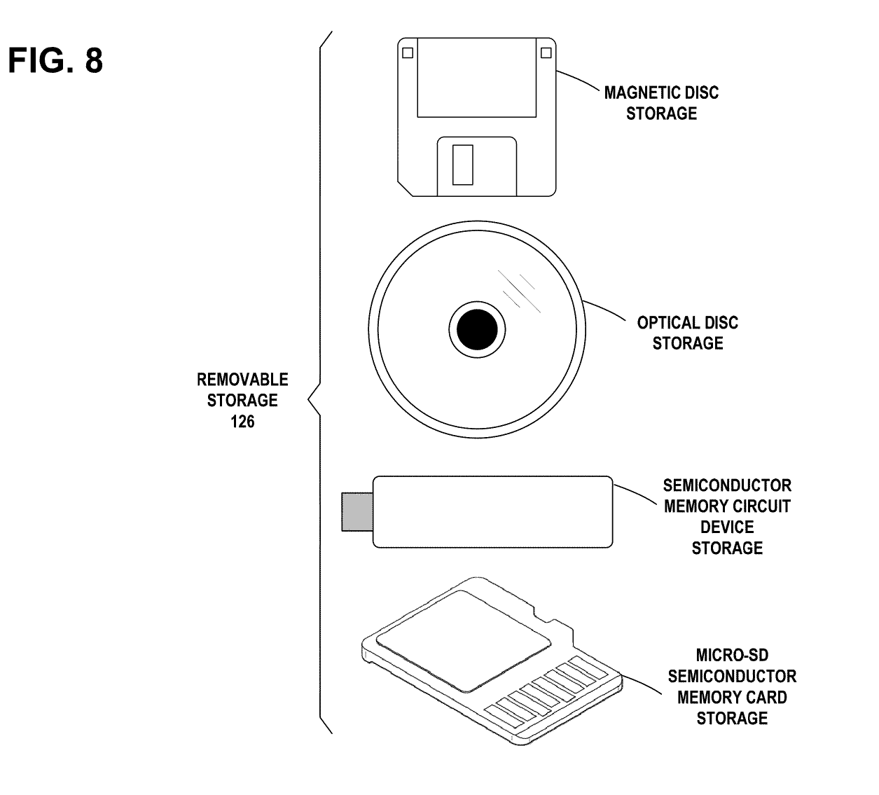

FIG. 8 illustrates an example embodiment of the invention, wherein examples of removable storage media 126 are shown. The removable storage media are based on magnetic, electronic and/or optical technologies, such as magnetic disks, optical disks, semiconductor memory circuit devices and micro-SD memory cards (SD refers to the Secure Digital standard). The removable storage media 126 are for storing data and/or computer program code as an example computer program product, in accordance with at least one embodiment of the present invention.

In an example embodiment of the invention, wireless networks may include other sensor type networks and/or other networks having a large number of supported stations/apparatuses. Examples of such networks include, for example cellular systems such as Global System for Mobile Communications (GSM), Wideband Code Division Multiple Access (W-CDMA), High Speed Packet Access (HSPA), Long Term Evolution (LTE), LTE Advanced (LTE-A), International Mobile Telecommunications Advanced (IMT-A), CDMA, Wireless Metropolitan Area Networks (WMAN) and Broadband Wireless Access (BWA) (LMDS, WiMAX, AIDAAS and HiperMAN), or the like networks. Examples of such networks include, for example, short-range networks such as Bluetooth, Zigbee, IEEE 802.11, Digital Enhanced Cordless Telecommunications (DECT), HiperLAN, Radio Frequency Identification (RFID), Wireless USB, DSRC (Dedicated Short-range Communications), Near Field Communication, wireless sensor networks, EnOcean; TransferJet, Ultra-wideband (UWB from WiMedia Alliance), WLAN, WiFi, and HiperLAN.

In accordance with an example embodiment of the invention, the STAs may be, for example, a miniature device such as a key fob, smart card, jewelry, or the like. The STAs may be, for example, a larger device such as a cell phone, smart phone, flip-phone, PDA, graphic pad, or even larger devices such as a laptop computer, an automobile, and the like.

In an example embodiment of the invention, an apparatus comprises:

means for receiving, by a station in an access network, a frame from another station in the access network or from an overlapped access network, indicating time restrictions for reserving a wireless medium, the frame including an indication in a first portion of the frame, indicating the presence of the time restrictions for reserving the wireless medium; and

means for decoding, by the station, at least a second portion occurring after the first portion of the received frame, to determine the time restrictions for reserving the wireless medium, in response to the indication.

In an example embodiment of the invention, an apparatus comprises:

means for transmitting, by an access node, a frame indicating time restrictions for reserving a wireless medium for stations in an access network of the of the access node or for overlapped access networks, the frame including an indication in a first portion of the frame, indicating the presence of the time restrictions for reserving the wireless medium; and

means for exchanging, by the access node, data frames with one or more stations in the access network or the overlapped access networks during a reserved time interval indicated by the time restrictions for reserving the wireless medium.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments of the invention have been disclosed, a person skilled in the art will understand that changes can be made to the specific example embodiments without departing from the spirit and scope of the invention.

What is claimed is:

1. A method, comprising:
receiving, by a station in an access network, a frame from another station in the access network or from an overlapped access network, indicating time restrictions for reserving a wireless medium, the frame including an indication in a first portion of the frame, indicating the presence of the time restrictions for reserving the wireless medium; and
decoding, by the station, at least a second portion occurring after the first portion of the received frame, to determine the time restrictions for reserving the wireless medium, in response to the indication.

2. The method of claim 1, wherein the station does not need to decode the entire received frame to learn about the time restrictions for reserving the wireless medium, when the time restrictions are for reserving the wireless medium for at least one of the overlapped access network and a third access network.

3. The method of claim 2, wherein the station sets a NAV to refrain from medium access during the reserved time, to reserve the wireless medium for the at least one of the overlapped access network and the third access network.

4. The method of claim 1, wherein the access network and the overlapped access network are both basic service sets and the access node is an access point.

5. The method of claim 1, wherein the access network is a short range network and the overlapped access network is a long range network.

6. The method of claim 1, wherein reserving the wireless medium comprises reserving the wireless medium for one of a restricted access window or a periodic restricted access window.

7. The method of claim 1, wherein the frame is a beacon frame and the indication is a bit located in a frame control field of the frame.

8. A method, comprising:
transmitting, by an access node, a frame indicating time restrictions for reserving a wireless medium for stations in an access network of the of the access node or for overlapped access networks, the frame including an indication in a first portion of the frame, indicating the presence of the time restrictions for reserving the wireless medium; and
exchanging, by the access node, data frames with one or more stations in the access network or the overlapped access networks during a reserved time interval indicated by the time restrictions for reserving the wireless medium.

9. The method of claim 8, wherein the access network and the overlapped access networks are basic service sets and the access node is an access point.

10. The method of claim 8, wherein the access network is a long range network and the overlapped access networks are short range networks.

11. The method of claim 8, wherein the frame further indicates time restrictions for reserving the wireless medium for the access network.

12. The method of claim 8, wherein reserving the wireless medium comprises reserving the wireless medium for a restricted access window for a subset of sensor networks.

13. The method of claim 8, wherein the transmitted frame is a beacon frame and the indication is a bit located in a frame control field of the frame.

14. The method of claim 8, wherein reserving the wireless medium comprises reserving the wireless medium for one of a restricted access window or a periodic restricted access window.

15. An apparatus, comprising:
at least one processor;
at least one memory including computer program code;
the at least one memory and the computer program code configured to, with the at least one processor, cause the apparatus at least to:
receive a frame from a station in an access network of the apparatus or from an overlapped access network, indicating time restrictions for reserving a wireless medium, the frame including an indication in a first portion of the frame, indicating the presence of the time restrictions for reserving the wireless medium; and
decode at least a second portion occurring after the first portion of the received frame, to determine the time restrictions for reserving the wireless medium, in response to the indication.

16. The apparatus of claim 15, wherein the access network and the overlapped access network are both basic service sets and the access node is an access point.

17. The apparatus of claim 15, wherein the access network is a short range network and the overlapped access network is a long range network.

18. An apparatus, comprising:
at least one processor;
at least one memory including computer program code;
the at least one memory and the computer program code configured to, with the at least one processor, cause the apparatus at least to:
transmit a frame indicating time restrictions for reserving a wireless medium for stations in an access network of the apparatus or for overlapped access networks, the frame including an indication in a first portion of the frame, indicating the presence of the time restrictions for reserving the wireless medium; and
exchange data frames with one or more stations in the access network or the overlapped access networks during an a reserved time interval indicated by the time restrictions for reserving the wireless medium.

19. A computer program product comprising computer executable program code recorded on a computer readable, non-transitory storage medium, the computer executable program code comprising:
code for receiving, by a station in an access network, a frame from another station in the access network or from an overlapped access network, indicating time restrictions for reserving a wireless medium, the frame including an indication in a first portion of the frame, indicating the presence of the time restrictions for reserving the wireless medium; and
code for decoding, by the station, at least a second portion occurring after the first portion of the received frame, to determine the time restrictions for reserving the wireless medium, in response to the indication.

20. A computer program product comprising computer executable program code recorded on a computer readable, non-transitory storage medium, the computer executable program code comprising:
code for transmitting, by an access node, a frame indicating time restrictions for reserving a wireless medium for stations in an access network of the of the access node or for overlapped access networks, the frame including an indication in a first portion of the frame, indicating the presence of the time restrictions for reserving the wireless medium; and
code for exchanging, by the access node, data frames with one or more stations in the access network or the overlapped access networks during a reserved time interval indicated by the time restrictions for reserving the wireless medium.
